(19) United States
(12) Patent Application Publication
(10) Pub. No.: US 2007/0176458 A1
(43) Pub. Date: Aug. 2, 2007

(54) Frost prevention device and method of use

(76) Inventor: Joseph Frederick Graham, Phoenix, AZ (US)

Correspondence Address: ERIC HANSCOM, 7395 PORTAGE WAY, CARLSBAD, CA, 92011, US

(21) Appl. No.: 11/636,719

(22) Filed: Dec. 11, 2006

Related U.S. Application Data
(60) Provisional application No. 60/758,958, filed on Jan. 17, 2006.

(51) Int. Cl. B60J 1/20

(52) U.S. Cl. 296/95.1

(57) ABSTRACT

This invention is directed toward a frost-prevention device which sits on a vehicle windshield. The invention consists of a thin sheet of suitable fabric with ends long enough to extend beyond the sides of the windshield into the space between the car door and the door jam. The invention also has top and bottom portions which may be tailored to accommodate the curves from the bottom of the windshield to the hood of the car and from the top of the windshield over the roof of the car as desired. Because the device can be physically restrained when a user closes a car door on the sides of the invention, it is not only theft-resistant but also can be secured to the windshield of a vehicle through this means, thereby allowing it to remain in place with no additional means of fastening the device to the window or windshield.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

This invention is directed toward a frost-prevention device which can be removably placed on and secured to a vehicle windshield. The invention consists of a thin sheet of vinyl, neoprene rubber, canvas, or other suitable fabric, shaped in a rectangle with ends long enough to extend beyond the sides of the windshield into the space between the car door and the door jam, thereby providing a mechanism by which a user of the invention can lock it in place to prevent theft. The invention also has top and bottom portions which may, optionally, be tailored to accommodate the curves from the bottom of the windshield to the hood of the car and from the top of the windshield over the roof of the car as desired. Because the device can be physically restrained when a user closes a car door on the sides of the invention, it is not only theft-resistant but also can be secured to the windshield of a vehicle through this means, thereby allowing it to remain in place with no additional means of securing. The invention comes with a carrying strap that also functions as a means to keep the invention rolled up and compact when not in use.

A key to the device is its relative simplicity, low cost, and ease of manufacture. The windshield cover is made from easily obtained materials, and can be cut in a variety of patterns, each designed to fit the known measurements and configurations of one or more windshields of popular cars and trucks. The edges can be sewn for a stronger and better looking finished product, but such sewing is, as sewing goes, a fairly basic and easily accomplished job, as it is mainly sewing the outer edge of an inwardly curving working piece.

With the advent of covered automobiles and other vehicles it was soon discovered that leaving such a vehicle overnight in freezing climates would often result in the formation of frost, which is a deposit of minute ice crystals which form when water vapor condenses at temperatures below freezing, on the windshield. Clearing off the frost from the windshield before using the automobile has been an inconvenience suffered by car and truck owners for over a century.

The prior has several examples of attempts to resolve this problem. For example, U.S. Pat. No. 4,973,098 to McFall teaches a flexible fabric sheet with side edges and a magnetic bar. While this patent appears to accomplish the same goal as does the present invention, it does so with considerably more devices and part, and with a correspondingly greater cost and degree of difficulty in manufacture and use. For example, the McFall patent uses magnetic bars, complementary pockets, and several layers of construction, as opposed to the current invention which provides the same result without any of the aforementioned limitations. Graham's invention, on the other hand, uses a more simple design—basically a sheet of material sewn in a particular pattern, and much less expensive materials.

Other prior art includes a number of equally complex inventions which, although directed toward solving the problem addressed by this invention, involve considerably more expensive, complicated, and difficult-to-use devices than that taught by the present invention. For example, U.S. Pat. No. 4,399,347 to Schmitt which teaches a flexible window covering for an automotive windshield which used suction of adhesive members to secure the sheet to the windshield to define an air space utilizing electrical resistance heaters to effect heating of the windshield and prevent of frost, fog, and the like. As with the McFall patent, this invention addresses the same need as Graham's windshield cover, but does so in a relative more expensive and complicated manner. U.S. Pat. No. 4,820,902 to Gillery provides an electrically heated transparent material utilized to overlie the vehicular windshield, while U.S. Pat. No. 4,203,198 to Hackett, et al. sets forth a heating panel defining a sandwich, including a serpentine configuration of resistance coil therewithin. U.S. Pat. No. 4,202,396 to Levy provides a motor vehicle sunshade utilizing securement means to adhere the organization to an interior surface of the windshield. Finally, U.S. Pat. No. 4,109,957 to Polizzi, et al. sets forth a removable automotive windshield curtain wherein an opaque cloth panel is provided to cover the vehicular windshield and side windows of a vehicle, such as recreational vehicles, utilizing a suction cup arrangement to secure the curtain to the windshield.

While these patents address, in one form or another, some of the needs met by Graham's windshield cover, they are all either more complicated, more expensive, and/or lacking in any form of locking device.

As such, it may be appreciated that there continues to be a need for a new and improved vehicular windshield frost preventive device as set forth by the instant invention which addresses both the problems of ease of use, as well as effectiveness in construction and providing an anti-theft solution, and in this respect the present invention substantially fulfills this need.

Thus there has existed a long-felt need for a frost-prevention device which effectively prevents the formation of frost on a windshield and yet is not overly expensive or difficult to use, and contains a simple anti-theft device.

The current invention provides just such a solution by having a thin sheet of material which sits on a vehicle's windshield and wraps around the sides of the windshield such that the front doors can be shut on the invention, effectively securing it such that it cannot be stolen easily and it remains in place a frost-prevention device which sits on a vehicle windshield. The invention consists of a thin sheet of vinyl, neoprene rubber, canvas, or other suitable fabric, shaped in a rectangle with ends long enough to extend beyond the sides of the windshield into the space between the car door and the door jam. The invention also has top and bottom portions which may be tailored to accommodate the curves from the bottom of the windshield to the hood of the car and from the top of the windshield over the roof of the car as desired. Because the device can be physically restrained when a user closes a car door on the sides of the invention, it is not only theft-resistant but also can be secured to the windshield of a vehicle through this means, thereby allowing it to remain in place with no additional means of fastening. The invention comes with a carry strap that also functions as a means to keep the invention rolled up and compact when not in use.

### SUMMARY OF THE INVENTION

It is a principal object of the invention to provide a device by which a vehicle user can prevent the formation of frost on a window.

It is another object of the invention that the frost prevention device is thin enough to slide in between the doors of a vehicle and the door jams, such that a user can slam the car doors on the device to prevent others from stealing it.

It is an additional object of the invention that due to the large range of fabric choices, the device can be made from a variety of materials, each of which may be advantageous characteristics for different climates.

A further object of this invention is to allow a manufacturer of the invention to custom tailor the size of the rectangular piece of fabric to various vehicular windows and windshields, thereby allowing a consumer to select a frost prevention device that fits his or her vehicle.

It is a final object of this invention the due to its inherent simplicity, the device may be easily, efficiently, and inexpensively manufactured and marketed.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

Attached are a number of figures that are drawings or photographs of the invention and its method of use. It is understood that when this provisional application is turned into a utility patent application these drawings will be done professionally.

FIG. 1 is a front view of the invention, showing the basic parts of its design.

FIG. 2 is a side view of the invention on a car windshield, locked in between the door and the door jam.

FIG. 3 is a top view of the invention illustrating how it wraps around the windshield of a vehicle and is secured against theft by closing the locking end inside of the door.

FIG. 4 is a front view of the invention on the windshield of a car.

FIG. 5 contains two side views of possible stitching patterns for the locking end of the invention.

### DETAILED DESCRIPTION OF THE INVENTION

The invention is a frost prevention device which comprises a rectangular sheet of fabric which, when stretched across the windshield of a vehicle, can be secured across the windshield by shutting the ends of the sheet of fabric into the driver and passenger doors of the vehicle. The material from which the sheet of fabric can be made can be neoprene, vinyl, canvas, or any other suitable material. The invention can be made for specific vehicles, such that it is sewn to accommodate the various curves found in the roof/windshield and hood/windshield points of connection found in a specific model of vehicle.

The invention can also be used to prevent the formation of frost on the rear and side windows of a vehicle, and can be secured by hooking the upper edge of the invention over the upper edge of the window prior to rolling it up.

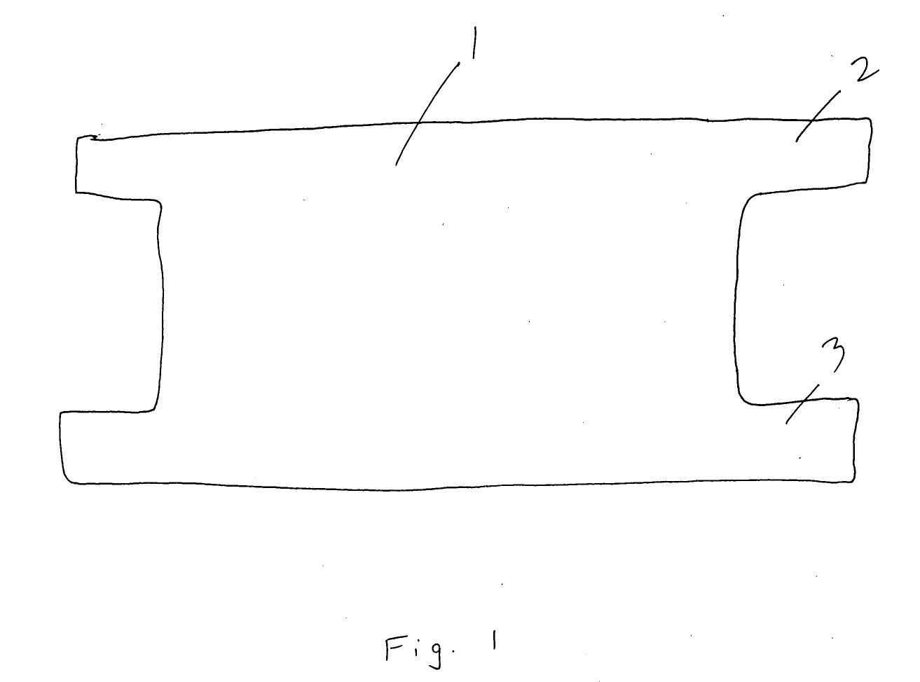

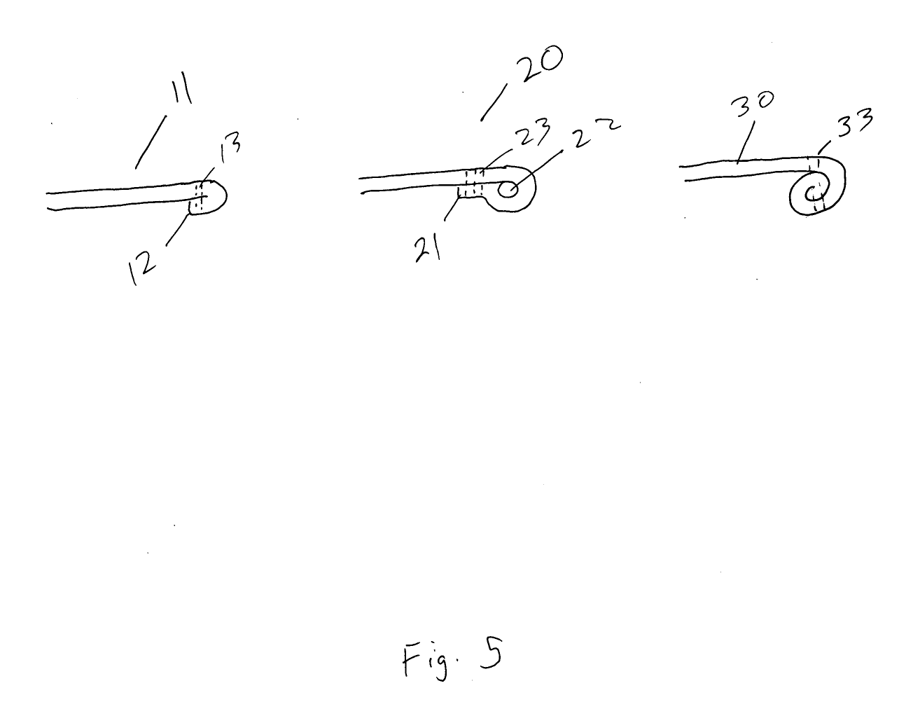

FIG. 1 is a front view of the invention, showing the simplicity of its design. It is basically a sheet of fabric, referred to as the body (1), designed to be deep enough to cover a vehicle's windshield from top to bottom, and wide enough to wrap around the sides and be secured inside the closed doors of the vehicle. The invention has locking ends which can be slipped in between the door and body of the vehicle. There can be upper locking ends (2) and/or lower locking ends (3). The locking ends can be rectangular, as shown in this figure, or of any other configuration. The locking ends may also have particular stitching patterns which enhance their anti-theft capabilities, as illustrated in FIG. 5.

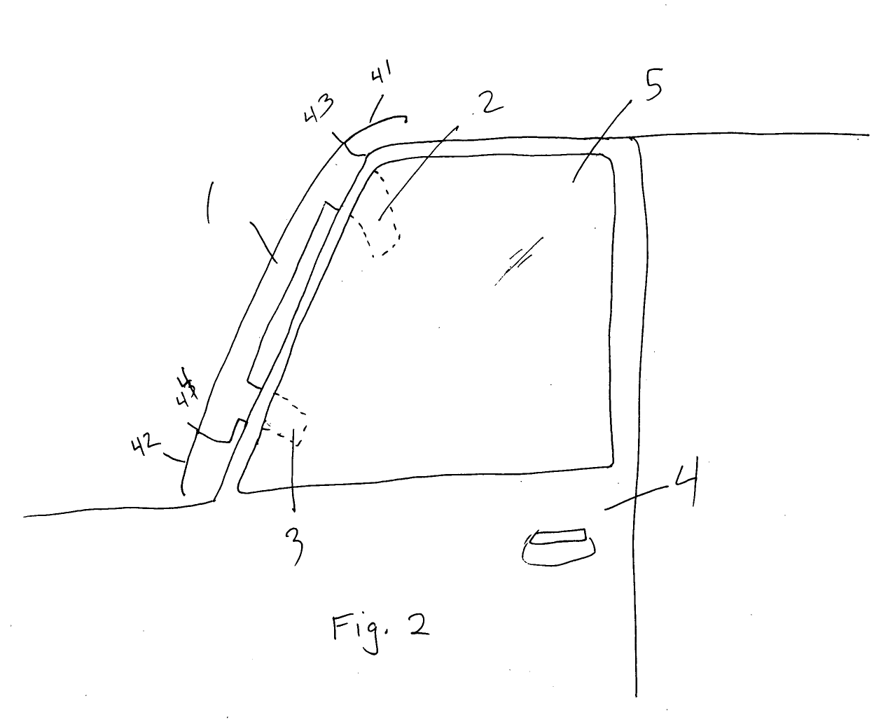

FIG. 2 is a side view of the invention on a car windshield, locked in between the door and the door jam. The body (1) is stretched across the windshield of a vehicle, and the upper end (2) and lower end (3) are secured by closing the door (4) of the car over the upper end (2) and lower end (3). Both locking ends can be seen through the window (5), thereby deterring potential thieves who can see how securely the locking ends are held by the door (4). FIG. 2 also illustrates the optional upper extension (41) and lower extension (42) which allow the device to conform to the curvature of the hood and the roof of the car. The extensions can either be removably attached by hook and loop, snaps, or another common and known means of attachment at the upper edge (43) and lower edge (44) of the body (1), or they can be manufactured into the body (1) itself.

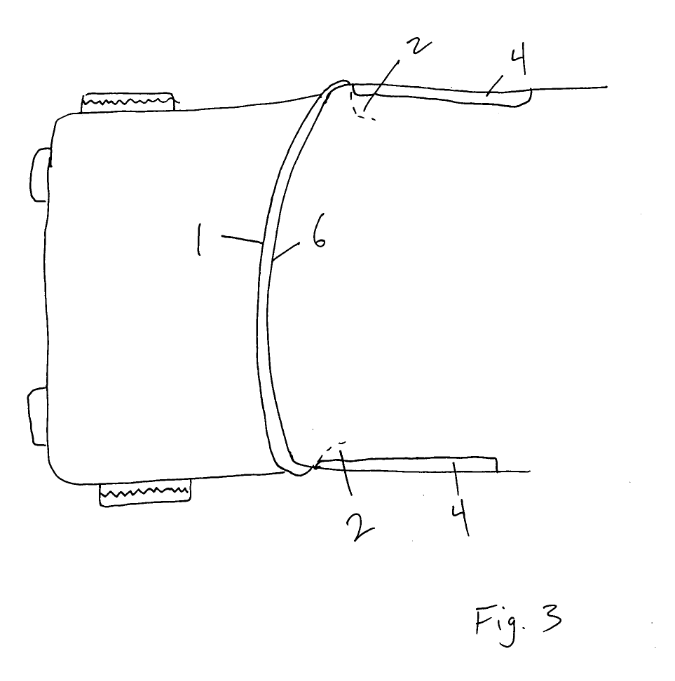

FIG. 3 is a top view of the invention illustrating how it wraps around the windshield of a vehicle and is secured against theft by closing the locking end inside of the door. The body (1) is wrapped across the windshield (6), with the upper ends (2) secured inside the closed doors (4).

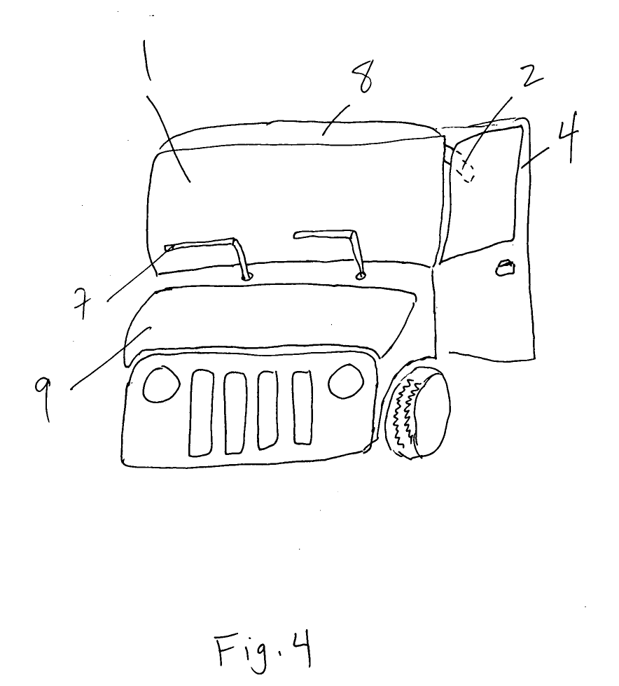

FIG. 4 is a front view of the invention on the windshield of a car. The body (1) is manufactured wide enough to cover the windshield up to the roof (8) and down to the hood (9) of a particular model of vehicle. The upper end (2) is secured inside of the closed door (4). Windshield wipers help to keep the body (1) close to the windshield.

FIG. 5 contains two side views of possible patterns for the locking end of the invention. A first method (11) has the terminal portion (12) of a locking end folded over back upon itself, and held in place by means of attachment (13) such as stitching or glue. A second method (20) has the terminal portion (21) of a locking end folded over a dowel (22) and back upon itself, and held in place by means of attachment (23) such as stitching or glue. Both methods create an enlarged terminal section, or terminal bulge, of a locking end, which will be more difficult to remove from a closed door. It is also envisioned the larger dowels (22) could be used to create an even larger terminal bulge, or that the terminal portion of the locking end could be first rolled up more than one revolution (30) and then secured in place by means of securement (33).

What I claim is:

1. A device for keep frost from forming on a glass portion of a vehicle, comprising: a piece of fabric with a top, a bottom, and two sides, where each of the two sides additionally comprise at least one locking end.

2. The device of claim 1, where each of the two sides additionally comprises two locking ends, where, the fabric has a shape, tall enough to reach from above the top of a vehicle window to below the bottom of the vehicle window, and long enough to stretch beyond the sides of the window and be secured between the door of the vehicle and the frame of the vehicle, near where the hinges are located.

3. The device of claim 1, where the shape is a rectangle.

4. The device of claim 1, where the shape is a square.

5. The device of claim 1, where the shape is an ellipse.

6. The device of claim 1, where the locking end additionally comprises a terminal portion, where the terminal portion is folded back upon the locking end and secured by means of securement.

7. The device of claim 6, where the means of securement is stitching.

8. The device of claim 6, where the means of securement is glue.

9. The device of claim 6, where the terminal portion is folded back upon the locking end more than one revolution.

10. The device of claim 6, additionally comprising a dowel, where the terminal end is folded over the dowel and secured to the locking end by means of securement.

11. The device of claim 1, where the top and bottom of the piece of fabric additionally comprise and upper extension and a lower extension that can be extended to accommodate the curvature of the hood and roof portions of the vehicle.

12. The device of claim 1, where the fabric is neoprene.

13. The device of claim 1, where the fabric is nylon.

14. The device of claim 1, where the fabric is vinyl.

15. The device of claim 1, where the fabric is canvas.

16. A method of preventing the formation of frost on a glass portion of a vehicle involving the steps of first, obtaining a device for keeping frost from forming on a glass portion of a vehicle, comprising: a piece of fabric with a top side, a bottom side, and two ends, where, the fabric is rectangular in shape, tall enough to reach from above the top of a vehicle window to below the bottom of the vehicle window, and long enough to stretch beyond the sides of the window and be secured between the door of the vehicle and the frame of the vehicle, near where the hinges are located, second, applying the device across the glass portion of the vehicle, third, closing the front doors of the vehicle over the ends of the device, fourth, leaving the device on the glass portion of the vehicle overnight, fifth, removing the device in the morning, and sixth, using the vehicle without first removing frost from the windshield.

17. A device for keep frost from forming on a glass portion of a vehicle, consisting of: a piece of fabric with a top, a bottom, and two sides, where each of the two sides additionally comprise at least one locking end, where, the fabric has a shape, tall enough to reach from above the top of a vehicle window to below the bottom of the vehicle window, and long enough to stretch beyond the sides of the window and be secured between the door of the vehicle and the frame of the vehicle, near where the hinges are located.

18. The device of claim 17, where the locking end additionally comprises a terminal portion, where the terminal portion is folded back upon the locking end and secured by means of securement.

19. The device of claim 17, where the top and bottom of the piece of fabric additionally comprise and upper extension and a lower extension that can be extended to accommodate the curvature of the hood and roof portions of the vehicle.

20. The device of claim 17, where the locking end additionally comprises a terminal portion, where the terminal portion is folded back upon the locking end more than one revolution and secured by means of securement.
